(19) United States
(12) Patent Application Publication
(10) Pub. No.: US 2026/0312105 A1
(43) Pub. Date: Oct. 8, 2026

(54) INTEGRATION OF FUEL CELL SYSTEM AND CO2 CAPTURE UNIT FOR HYDROGEN PRODUCTION

(71) Applicant: UOP LLC, Des Plaines, IL (US)

(72) Inventor: Bradley Russell, Longmont, CO (US)

(21) Appl. No.: 19/421,208

(22) Filed: Dec. 16, 2025

Related U.S. Application Data
(60) Provisional application No. 63/783,278, filed on Apr. 4, 2025.

(51) Int. Cl. H01M 8/0668; B01D 53/00; B01D 53/047; B01D 53/14; B01D 53/26; H01M 8/04089; H01M 8/12; H01M 8/14

(52) U.S. Cl. CPC H01M 8/0668; B01D 53/002; B01D 53/047; B01D 53/1475; B01D 53/265; H01M 8/04097; H01M 8/12; H01M 8/14; B01D 2256/10; B01D 2256/16; B01D 2256/18; B01D 2256/20; B01D 2256/245; B01D 2257/504; H01M 2008/1293; H01M 2008/147

(57) ABSTRACT

Processes are described for integrating fuel cells to generate electricity with a process unit which generates a CO₂-rich process gas stream, and a CO₂ capture unit to recover CO₂ for sequestration or use as a reactant in a process. Carbon emissions from the fuel cells are reduced, enabling clean electricity generation. The cost of CO₂ capture in fuel cell systems is significantly reduced compared to flue gas CO₂ capture on gas turbine power plants because the anode off gas stream is much more concentrated in CO₂ than conventional gas turbine exhaust.

### RELATED APPLICATIONS

This application claims priority to U.S. Provisional Patent Application Ser. No. 63/783,278, filed on Apr. 4, 2025, the entirety of which is incorporated herein by reference.

### BACKGROUND

For some large-scale greenfield blue hydrogen or blue ammonia projects, an electrical power plant will be constructed on site in order to provide electricity for the process. These projects are typically based on autothermal reforming of natural gas, and a gas turbine process is generally used for the power plant (natural gas combined cycle (NGCC). An amine solvent unit is used on the NGCC flue gas to capture CO₂ emissions from the power plant. However, the amine solvent unit and associated CO₂ drying and compression systems are expensive to provide and to operate.

Fuel cells are an emerging technology for electricity generation. Fuel cells convert fuels, such as natural gas, hydrogen-rich off gas streams containing hydrocarbons, and the like, into electricity utilizing electrochemical reactions. Solid oxide and carbonate fuel cells incorporate internal steam reforming and water-gas shift on the anode side to convert the fuel gas to hydrogen and carbon monoxide/carbon dioxide. Hydrogen reacts with oxygen ions (solid oxide fuel cell) or carbonate ions (carbonate fuel cell) to form water vapor and electricity. The anode off gas comprises significant quantities of carbon dioxide, as well as byproduct hydrogen, carbon monoxide, and residual methane.

It would be desirable to provide alternate sources of electricity for hydrogen and ammonia plants and other types of processes, and to reduce the cost of associated carbon capture processes.

### BRIEF DESCRIPTION OF THE DRAWINGS

FIG. 1 is an illustration of one embodiment of a fuel cell integrated with a process having a CO₂ capture unit according to the present invention.

FIG. 2 is an illustration another one embodiment of a fuel cell integrated with a hydrogen production process having a CO₂ capture unit according to the present invention.

### DESCRIPTION

The integrated process of the present invention includes a fuel cell to generate electricity, a process unit which generates a CO₂-rich process gas stream, and a CO₂ capture unit to recover CO₂ for sequestration or for utilization as a reactant in a process.

Carbon emissions from fuel cells are reduced when CO₂ is captured from the anode exhaust gas and geologically sequestered or utilized, thereby enabling clean electricity generation. The anode off gas stream is much more concentrated in CO₂ (e.g., about 45 to 65 mol %, dry basis) compared to conventional gas turbine exhaust (e.g., about 5 mol %, dry basis). As a result, the cost of CO₂ capture in fuel cell systems is significantly reduced compared to flue gas CO₂ capture on gas turbine power plants.

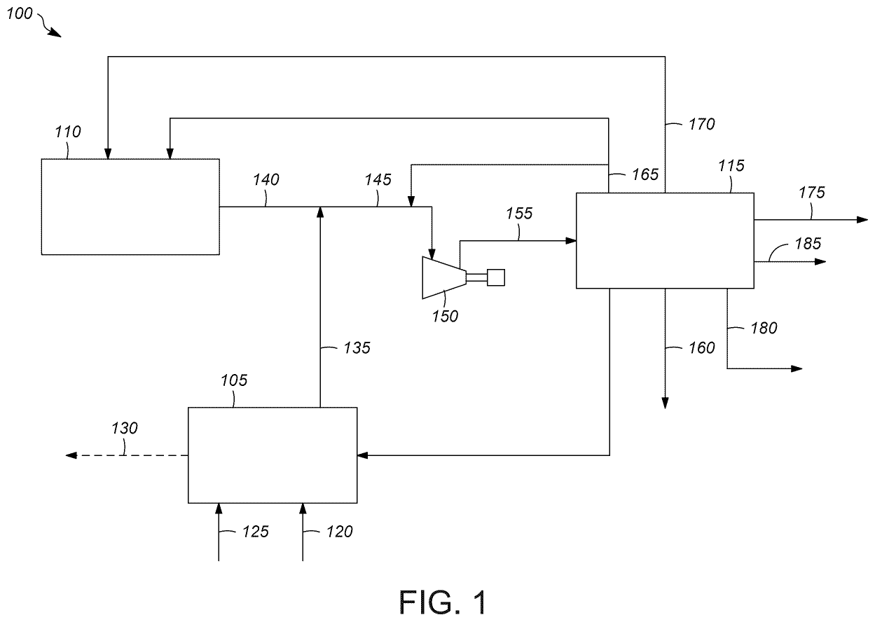

One embodiment of a process 100 integrating a fuel cell 105 with a process unit 110 including a CO₂ capture unit 115 is shown in FIG. 1.

The fuel cell 105 comprises an anode, a cathode, and an electrolyte. The fuel cell 105 can be a solid oxide fuel cell or a carbonate fuel cell (also known as a molten carbonate fuel cell).

The anode feed gas stream 120 to the fuel cell can be a hydrocarbon stream, such as natural gas and/or liquefied petroleum gas (LPG), and steam. Other gas feed streams, such as a hydrogen gas stream, a hydrogen-rich gas stream, a synthesis gas stream (hydrogen and carbon monoxide (CO)) with or without hydrocarbons can also be used, either as an alternative feed stream or as a supplement. For example, the residue stream from a CO₂ capture unit can be recycled to the anode.

The cathode feed gas stream 125 to a solid oxide fuel cell can be any suitable oxygen-containing stream, such as air or another oxygen-containing stream, or pure oxygen. The cathode feed gas stream 125 to a carbonate fuel cell can be any suitable gas stream containing oxygen and CO₂. It could be mixed with other streams containing CO₂ as well as other components, such as flue gas from an industrial process, and the like.

The fuel cell 105 produces electricity 130 and an anode off gas stream 135 comprising CO₂ and at least one of hydrogen, CO, methane, water, and nitrogen. The electricity 130 can be used to drive a compressor, or another piece of process equipment in the process, or a piece of equipment in a different process, or it can be exported to an electrical grid, or combinations thereof.

The anode off gas stream 135 is at high temperature (e.g., 100° C. to 200° C.) and contains a large amount of water vapor, e.g., about 30 to 50 mol %. The anode off gas stream is cooled to about 30° C. to 50° C. using air, cooling water, or direct water quench, of for example, and water in the cooled anode off gas stream is condensed (not shown) to remove most of the water. The water vapor content of the cooled anode off gas stream is about 5 to 10 mol %.

The process unit 110 produces a CO₂-rich process gas stream 140. Various process gas streams may be used, including, but not limited to, a tail gas stream from a pressure swing adsorption (PSA) system, an off gas stream from a kiln in a cement production process, an off gas stream from a steel production process, a synthesis gas stream from a biomass or waste gasification process, or combinations thereof.

The process gas stream 140 from the process unit 110 is mixed with the cooled, anode off gas stream 135 from the fuel cell 105.

The mixed gas stream 145 is compressed in compressor 150, and the compressed mixed gas stream 155 is sent to the CO₂ capture unit 115. Suitable CO₂ capture units 115 include, but are not limited to, cryogenic CO₂ fractionation systems, CO₂ PSA systems, liquid solvent-based systems, or combinations thereof. The CO₂ capture unit 115 may also include additional PSA units and/or membrane units for recovery of hydrogen and fuel gas (including de-carbonized fuel gas), CO₂ recycle streams, and production of CO and methane enriched residue gas.

The CO₂ capture unit 115 can produce a number of different streams, including one or more of the following: a CO₂ product stream 160, a CO₂ recycle stream 165, a residue stream 170, a hydrogen stream 175, a fuel gas stream 180, or a synthesis gas stream 185. The CO₂ product stream 160 may have a purity of 95 mol % or more and may be sent for sequestration or use in other processes. The CO₂ recycle stream 165, which comprises CO₂, and other components, such as nitrogen, hydrogen, methane, CO, and argon, may be recycled to the process unit 110 or combined with the mixed gas stream 145 and returned to the CO₂ capture unit 115. The residue stream 170 comprises one or more of CO, methane, hydrogen, nitrogen, and argon and may be recycled to the process unit 110 or to the anode of the fuel cell 105. The hydrogen stream 175 may comprise hydrogen having a purity of 99 mol % or more and may be recovered. The fuel gas stream 180 may be a slip stream of the residue stream 170 (comprising one or more of hydrogen, methane, CO, nitrogen, and argon) and may be burned to remove nitrogen and/or argon from the process. The fuel gas stream 180 may also be a decarbonized gas stream, comprising hydrogen and inerts (nitrogen and/or argon) which may be burned to remove nitrogen and/or argon from the process. A CO₂-lean synthesis gas stream 185 may also be produced within the CO₂ capture unit 115. This syngas stream comprises hydrogen and CO and can be used for downstream chemical synthesis (e.g., methanol production or liquid fuels production using a Fischer-Tropsch process).

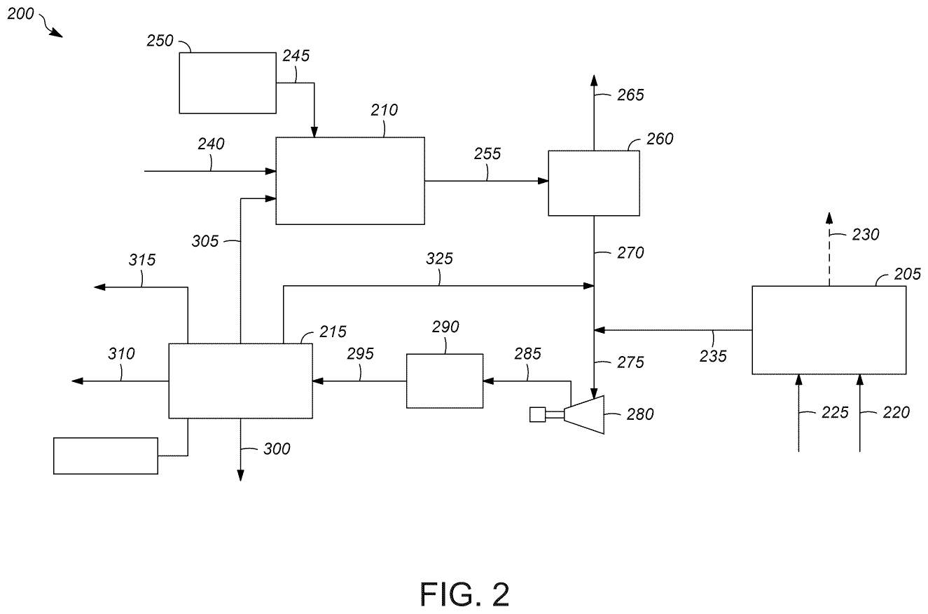

Another embodiment of a process 200 integrating a fuel cell 205 with a process unit 210 including a CO₂ capture unit 215 is shown in FIG. 2.

The fuel cell 205 comprises an anode, a cathode, and an electrolyte. The fuel cell 205 can be a solid oxide fuel cell or a carbonate fuel cell.

The anode feed gas stream 220 to the fuel cell can be a hydrocarbon stream, such as natural gas and steam. Other gas feed streams can also be used, as described above.

The cathode feed gas stream 225 to a solid oxide fuel cell can be an oxygen-containing stream, such as air. The cathode feed gas stream 225 to a carbonate fuel cell can be any gas stream containing oxygen and CO₂. It could be mixed with other streams containing CO₂, flue gas from an industrial process, and the like.

The fuel cell 205 produces electricity 230 and an anode off gas stream 235 comprising CO₂ and at least one of hydrogen, CO, methane, water, and nitrogen. The electricity 230 can be used for a variety of purposes in the process 200 or in other processes, as discussed above.

The process unit 210 is an autothermal reformer with a water gas shift reactor (ATR/WGS). The process feed stream 240 comprises a hydrocarbon stream, such as natural gas. An oxygen gas stream 245 from (ASU) 250 is also sent to the ATR/WGS process unit 210.

The ATR/WGS process unit 210 produces a CO₂ containing synthesis gas stream 255 which is sent to a H₂ PSA system 260. The H₂ PSA system 260 produces a high pressure, high purity hydrogen stream (e.g., greater than or equal to 99 mol %) 265 and a low pressure tail gas stream 270 comprising CO₂, methane, CO, nitrogen, argon, and an unrecovered portion of the hydrogen in synthesis gas stream 255. The H₂ PSA system 260 could be a conventional two product PSA unit, or a three product PSA unit, as described in U.S. Pat. No. 12,036,505, with the intermediate pressure vent gas stream comprising hydrogen, and nitrogen and/or argon, which can be used as a decarbonized fuel gas.

The tail gas stream 270 is mixed with the cooled, anode off gas stream 235 (as described above) from the fuel cell 205, and the mixed gas stream 275 is compressed in tail gas compressor tail gas 280.

The compressed mixed gas stream 285 is sent to drier 290. The dried compressed mixed gas stream 295 is sent to the CO₂ capture unit 215, which is a cryogenic CO₂ fractionation system.

The CO₂ capture unit 215 produces a CO₂ product stream 300, a residue gas stream 305, a hydrogen stream 310, a CO₂ recycle stream 325, and a fuel gas stream 315. The CO₂ product stream 300 may have a purity of 95 mol % or more and may be sent for sequestration or use in other processes. The residue gas stream 305 is recycled to the ATR/WGS process unit 210. The hydrogen stream 310 may comprise hydrogen having a purity of 99 mol % or more and may be recovered. The fuel gas stream 315 may be burned to remove nitrogen and/or argon from the process. The CO₂ recycle stream 325 is passed to tail gas compressor 280, thereby avoiding CO₂ loss from the system and enabling high net overall CO₂ recovery from the process (e.g., greater than 97%, or greater than 98%, or greater than 99% CO₂ capture from streams 270 and 235).

The anode off gas stream 235 is passed to the suction of the H₂ pressure swing adsorption (PSA) tail gas compressor 280 after cooling and water condensation/knock-out. This eliminates a separate anode off gas compressor because only a blower is required to increase the pressure from about 0.2 psig to about 5 psig. The upstream ATR/WGS process unit 210 and the H₂ PSA system 260 are not adversely affected. The anode off gas stream 235 has a similar composition to the H₂ PSA tail gas stream 270 and is passed to the tail gas compressor 280. The hydrogen in the anode off gas stream 235 is recovered in the CO₂ capture unit 215 (including overhead PSA units) in hydrogen stream 310, and the carbon monoxide and methane in the anode off gas stream 235 is recycled in the residue gas stream 305 to the ATR/WGS process unit 210.

### EXAMPLES

An industrial process produces a CO₂ rich process gas. In some cases, the process includes a pressure swing adsorption unit, and the CO₂ rich process gas comprises low-pressure PSA tail gas. The compositions below are based on computer simulations. Examples of such processes include the following:

### Example 1: Hydrogen and/or Ammonia Production Process Based on Autothermal Reforming (ATR)

In this case (as shown in FIG. 2), a hydrogen PSA unit is used to recover high-purity hydrogen from the synthesis gas for export and/or for ammonia synthesis. The CO₂ rich process gas comprises a hydrogen PSA tail gas. For example, the PSA tail gas below is produced in a 6000 metric ton per day (MTPD) blue ammonia process based on autothermal reforming of natural gas. This tail gas is passed to a gas compressor and then to a CO₂ capture system (a cryogenic system).

| | |
|---|---|
| Pressure, kPa | 135 |
| Temperature, ° C. | 10 |
| Flow, kgmol / hr | 12,115 |
| Composition, mol % | |
| CO₂ | 75.211 |
| Hydrogen | 18.392 |
| Carbon Monoxide | 1.421 |
| Methane | 3.569 |
| Water | 0.421 |
| N₂ | 0.957 |
| Argon | 0.018 |
| Methanol | 0.011 |

### Example 2: Cement Production Process

The cement kiln flue gas is compressed and passed to a PSA unit. The CO₂ rich process gas comprises PSA tail gas. For example, the PSA tail gas below is produced from a cement production process. The tail gas is passed to a gas compressor and then to a CO₂ capture system (a cryogenic system).

| | |
|---|---|
| Pressure, kPa | 135 |
| Temperature, ° C. | 36 |
| Flow, kgmol / hr | 4428 |
| Composition, mol % | |
| N₂ | 26.601 |
| CO₂ | 70.893 |
| Oxygen | 1.541 |
| Water | 0.869 |
| Carbon Monoxide | 0.078 |
| Ammonia | 18 ppmv |
| SO₂ | 8 ppmv |
| NO₂ | 84 ppmv |
| NO | 81 pmv |

### Example 3: Biomass or Municipal Solid Waste Gasification Process

The feedstock is gasified in the presence of oxygen and steam to produce a synthesis gas. This low-pressure CO₂ rich synthesis gas can be passed directly to a compressor and then to a CO₂ capture system. The decarbonized synthesis gas can be used for synthesis of methanol or liquid hydrocarbon fuels via the Fischer-Tropsch process. For example, the synthesis gas below is produced in a biomass gasification process. This CO₂ rich process gas is passed to a gas compressor and then to a CO₂ capture system (comprising a CO₂ PSA unit). Following CO₂ capture and trace contaminant removal, the decarbonized synthesis gas is used for methanol synthesis.

| | |
|---|---|
| Pressure, kPa | 108 |
| Temperature, ° C. | 39 |
| Flow, kgmol / hr | 1302 |
| Composition, mol % | |
| Methane | 2.299 |
| N₂ | 0.200 |
| Hydrogen | 32.485 |
| CO₂ | 36.583 |
| Carbon Monoxide | 21.690 |
| Argon | 0.200 |
| Water | 6.497 |
| Carbonyl Sulfide | 8 ppmv |
| H₂S | 0.023 |
| HCl | 3 ppmv |
| Ammonia | 86 ppmv |
| Benzene | 0.013 |

### Example 4: Steel Production Process

Blast furnace off gas is passed to a water-gas shift reactor. This low-pressure shifted CO₂ rich process gas is passed to a gas compressor and then to a CO₂ capture system (comprising multiple CO₂ PSA units). For example, the shifted CO₂ rich process gas below is produced from a blast furnace steel production process.

| | |
|---|---|
| Pressure, kPa | 115 |
| Temperature, ° C. | 33 |
| Flow, kgmol / hr | 25,940 |
| Composition, mol % | |
| N₂ | 36.890 |
| Hydrogen | 22.000 |
| CO₂ | 32.600 |
| Carbon Monoxide | 3.830 |
| Argon | 0.480 |
| Water | 4.200 |

### Example 5: Steel Production Based on Direct Reduction of Iron (DRI) Process

A CO₂ rich process gas is comprised of DRI off gas. This off gas is passed to a gas compressor and then to a CO₂ capture system (comprising a CO₂ PSA unit). For example, the CO₂ rich process gas below is produced from a DRI steel production process.

| | |
|---|---|
| Pressure, kPa | 120 |
| Temperature, ° C. | 42 |
| Flow, kgmol / hr | 8138 |
| Composition, mol % | |
| Methane | 1.599 |
| N₂ | 13.547 |
| Hydrogen | 14.111 |
| CO₂ | 30.668 |
| Carbon Monoxide | 33.208 |
| Water | 6.868 |

### Example 6

A fuel cell is used to produce electrical power for the compressor and other consumers in the process and possibly for export to the electrical grid. This can be a solid oxide fuel cell (SOFC) or a molten carbonate fuel cell (MCFC). The fuel cell comprises an anode, a cathode, and an electrolyte. A hydrocarbon fuel (such as natural gas) is passed to the anode, along with steam. A hydrogen containing synthesis gas is produced in situ within the anode (via steam reforming and water-gas shift reactions). Air (SOFC) or a CO₂ and oxygen containing stream such as flue gas (MCFC) is passed to the cathode. Hydrogen is consumed within the fuel cell to generate electricity. The anode and cathode exhaust gases exit the fuel cell. Examples of anode exhaust gases are given below. The anode off gas can be cooled, and liquid water can be condensed and separated from the anode exhaust gas. This cooled anode off gas is mixed with the CO₂ rich process gas and then passed to a gas compressor.
A: 150 MW Solid Oxide Fuel Cell-Anode Exhaust Gas (after cooling and water separation)

| | |
|---|---|
| Pressure, kPa | 108 |
| Temperature, ° C. | 40 |
| Flow, kgmol / hr | 1980 |
| Composition, mol % | |
| Methane | 0.205 |
| N₂ | 0.605 |
| Hydrogen | 23.070 |
| CO₂ | 57.888 |
| Carbon Monoxide | 11.330 |
| Water | 6.903 |

B: Carbonate Fuel Cell-Anode Exhaust Gas (after cooling and water separation)

| | |
|---|---|
| Pressure, kPa | 108 |
| Temperature, ° C. | 40 |
| Flow, kgmol / hr | 2583 |
| Composition, mol % | |
| Methane | 1.433 |
| N₂ | 0.716 |
| Hydrogen | 32.947 |
| CO₂ | 50.130 |
| Carbon Monoxide | 7.876 |
| Water | 6.899 |

### Example 7

The CO₂ capture system can be a cryogenic CO₂ fractionation system, a CO₂ PSA unit or units, or a liquid solvent-based system. Additional PSA units or membrane units can be used within the CO₂ capture system to recover purified hydrogen product, fuel gas streams (including decarbonized fuel gas), CO₂ recycle streams, and residue gas (comprising un-recovered hydrogen, carbon monoxide, and methane). Product hydrogen can be recovered at high pressure (e.g., 2000 to 4000 kPa) and high purity (e.g., 99.0 to 99.99 mol %). Carbon dioxide can be recovered as a liquid product (e.g., 1000 to 2000 kPa and −50° C. to −20° C.) for rail, truck, or ship transport, a gas-phase product for intermediate pipeline transport (e.g., 2000 to 4000 kPa and 30° C. to 50° C.), or as a high-pressure supercritical product for pipeline transport (e.g., 10,000 to 20,000 kPa and 30° C. to 50° C.). The purity of the CO₂ product can range from 95 mol % to 99.99 mol %. Fuel gas can be comprised of a slipstream of residue gas (i.e., carbon monoxide, methane, nitrogen, argon, and un-recovered hydrogen) or as a de-carbonized hydrogen-rich stream comprising nitrogen and argon. Examples of fuel gas and residue gas streams are given below for a 6000 metric ton per day (MTPD) blue ammonia process.

Fuel Gas

| | |
|---|---|
| Pressure, kPa | 310 |
| Temperature, ° C. | 38 |
| Flow, kgmol / hr | 3255 |
| Composition, mol % | |
| CO₂ | 0.065 |
| Hydrogen | 89.380 |
| Carbon Monoxide | 2.043 |
| Methane | 4.657 |
| Water | 0.000 |
| N₂ | 3.777 |
| Argon | 0.079 |

Residue Gas

| | |
|---|---|
| Pressure, kPa | 135 |
| Temperature, ° C. | 34 |
| Flow, kgmol / hr | 639 |
| Composition, mol % | |
| CO₂ | 0.525 |
| Hydrogen | 34.277 |
| Carbon Monoxide | 16.547 |
| Methane | 37.321 |
| Water | 0.000 |
| N₂ | 11.143 |
| Argon | 0.187 |

### Specific Embodiments

While the following is described in conjunction with specific embodiments, it will be understood that this description is intended to illustrate and not limit the scope of the preceding description and the appended claims.

A first embodiment of the invention is a process for integrating a fuel cell with a process including a CO₂ capture unit comprising introducing an anode feed gas stream to an anode of a fuel cell and a cathode feed stream to a cathode of the fuel cell, wherein the anode feed gas stream comprises one or more of hydrogen, carbon monoxide, water vapor, and a hydrocarbon and the cathode feed stream comprises oxygen, or oxygen and CO₂, the fuel cell generating electricity and producing an anode off gas stream comprising CO₂ and at least one of hydrogen, CO, methane, water, and nitrogen; mixing the anode off gas stream with a process gas stream from the process to form a gas mixture, the process gas stream comprising CO₂ and at least one of nitrogen, oxygen, hydrogen, CO, methane, argon, and water; compressing the gas mixture in a compressor to form a compressed gas mixture; passing the compressed gas mixture to the CO₂ capture unit; recovering CO₂ in the CO₂ capture unit. An embodiment of the invention is one, any or all of prior embodiments in this paragraph up through the first embodiment in this paragraph wherein the electricity is used to drive the compressor, or another piece of process equipment in the process, or a piece of equipment in a second process, or is exported to an electrical grid, or combinations thereof. An embodiment of the invention is one, any or all of prior embodiments in this paragraph up through the first embodiment in this paragraph wherein the fuel cell comprises a solid oxide fuel cell or a carbonate fuel cell or both. An embodiment of the invention is one, any or all of prior embodiments in this paragraph up through the first embodiment in this paragraph wherein the anode feed gas stream comprises natural gas. An embodiment of the invention is one, any or all of prior embodiments in this paragraph up through the first embodiment in this paragraph wherein the CO₂ capture unit comprises a cryogenic CO₂ fractionation system, or a CO₂ PSA system, or a liquid solvent-based system, or combinations thereof. An embodiment of the invention is one, any or all of prior embodiments in this paragraph up through the first embodiment in this paragraph wherein the process gas stream comprises a tail gas stream from a pressure swing adsorption (PSA) system, or an off gas stream from a kiln in a cement production process, or an off gas stream from a steel production process, or a synthesis gas stream from a biomass or waste gasification process, or combinations thereof. An embodiment of the invention is one, any or all of prior embodiments in this paragraph up through the first embodiment in this paragraph wherein the process gas stream comprises a tail gas stream from a PSA system, and wherein a feed to the PSA system comprises a synthesis gas stream from a hydrogen production process, a synthesis gas stream from a biomass or waste gasification process, an off gas stream from a kiln in a cement production process, an off gas stream from a steel production process, or combinations thereof. An embodiment of the invention is one, any or all of prior embodiments in this paragraph up through the first embodiment in this paragraph further comprising recovering hydrogen from the anode off gas stream in the CO₂ capture unit. An embodiment of the invention is one, any or all of prior embodiments in this paragraph up through the first embodiment in this paragraph further comprising producing a residue gas stream comprising CO and methane in the CO₂ capture unit; and recycling the residue gas stream to the fuel cell, or recycling the residue gas stream to the process, or both. An embodiment of the invention is one, any or all of prior embodiments in this paragraph up through the first embodiment in this paragraph further comprising producing a decarbonized fuel gas stream comprising hydrogen and nitrogen in the CO₂ capture unit; and combusting the decarbonized fuel gas stream a fired heater in the process or another process or both. An embodiment of the invention is one, any or all of prior embodiments in this paragraph up through the first embodiment in this paragraph further comprising cooling the anode off gas stream; and condensing water in the cooled anode off gas stream forming a condensed water stream and a cooled anode off gas stream; separating the condensed water stream from the cooled anode off gas stream; wherein mixing the anode off gas stream with the process gas stream comprises mixing the cooled anode off gas stream with the process gas stream. An embodiment of the invention is one, any or all of prior embodiments in this paragraph up through the first embodiment in this paragraph wherein the process gas stream has a pressure in a range of 100 to 180 kPa; or wherein the anode off gas stream has a pressure in a range of 100 to 180 kPa; or both. An embodiment of the invention is one, any or all of prior embodiments in this paragraph up through the first embodiment in this paragraph wherein the anode off gas stream (on a dry basis) comprises 15 to 45 mol % hydrogen, or 45 to 65 mol % CO₂, or 5 to 15 mol % CO, or combinations thereof. An embodiment of the invention is one, any or all of prior embodiments in this paragraph up through the first embodiment in this paragraph wherein the CO₂ capture unit produces a CO₂ product stream comprising CO₂ having a purity greater than or equal to 95 mol %; or a hydrogen stream comprising hydrogen having a purity greater than or equal to 99 mol %; or a residue gas stream comprising at least one of CO, methane, hydrogen, nitrogen, and argon; or a fuel gas stream comprising a slip stream of the residue gas stream; or a decarbonized fuel gas stream comprising hydrogen, and nitrogen or argon or both; or combinations thereof.

A second embodiment of the invention is a process for integrating a fuel cell with a process including a CO₂ capture unit comprising introducing an anode feed gas stream to an anode of a fuel cell and a cathode feed stream to a cathode of the fuel cell, wherein the anode feed gas stream comprises one or more of hydrogen, carbon monoxide, water vapor, and a hydrocarbon and the cathode feed stream comprises oxygen, or oxygen and CO₂, the fuel cell generating electricity and producing an anode off gas stream comprising CO₂ and at least one of hydrogen, CO, methane, water, and nitrogen, wherein the fuel cell comprises a solid oxide fuel cell or a carbonate fuel cell or both; cooling the anode off gas stream; condensing water in the cooled anode off gas stream forming a condensed water stream and a cooled anode off gas stream; separating the condensed water stream from the cooled anode off gas stream; mixing the cooled anode off gas stream with a process gas stream from the process to form a gas mixture, the process gas stream comprising CO₂ and at least one of nitrogen, oxygen, hydrogen, CO, methane, argon, and water; compressing the gas mixture in a compressor to form a compressed gas mixture; passing the compressed gas mixture to the CO₂ capture unit; and recovering CO₂ in the CO₂ capture unit. An embodiment of the invention is one, any or all of prior embodiments in this paragraph up through the second embodiment in this paragraph wherein the CO₂ capture unit comprises a cryogenic CO₂ fractionation system, or a CO₂ PSA system, or a liquid solvent-based system, or combinations thereof An embodiment of the invention is one, any or all of prior embodiments in this paragraph up through the second embodiment in this paragraph wherein the process gas stream comprises a tail gas stream from a pressure swing adsorption (PSA) system, or an off gas stream from a kiln in a cement production process, or an off gas stream from a steel production process, or a synthesis gas stream from a biomass or waste gasification process, or combinations thereof. An embodiment of the invention is one, any or all of prior embodiments in this paragraph up through the second embodiment in this paragraph further comprising recovering hydrogen from the anode off gas stream in the CO₂ capture unit. An embodiment of the invention is one, any or all of prior embodiments in this paragraph up through the second embodiment in this paragraph further comprising producing a residue gas stream comprising CO and methane in the CO₂ capture unit; and recycling the residue gas stream to the fuel cell, or recycling the residue gas stream to the process, or both. An embodiment of the invention is one, any or all of prior embodiments in this paragraph up through the second embodiment in this paragraph further comprising producing a decarbonized fuel gas stream comprising hydrogen and nitrogen in the CO₂ capture unit; and combusting the decarbonized fuel gas stream a fired heater in the process or another process or both.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for integrating a fuel cell with a process including a CO₂ capture unit comprising:
introducing an anode feed gas stream to an anode of a fuel cell and a cathode feed stream to a cathode of the fuel cell, wherein the anode feed gas stream comprises one or more of hydrogen, carbon monoxide, water vapor, and a hydrocarbon and the cathode feed stream comprises oxygen, or oxygen and CO₂, the fuel cell generating electricity and producing an anode off gas stream comprising CO₂ and at least one of hydrogen, CO, methane, water, and nitrogen;
mixing the anode off gas stream with a process gas stream from the process to form a gas mixture, the process gas stream comprising CO₂ and at least one of nitrogen, oxygen, hydrogen, CO, methane, argon, and water;
compressing the gas mixture in a compressor to form a compressed gas mixture;
passing the compressed gas mixture to the CO₂ capture unit; and
recovering CO₂ in the CO₂ capture unit.

2. The process of claim 1 wherein the electricity is used to drive the compressor, or another piece of process equipment in the process, or a piece of equipment in a second process, or is exported to an electrical grid, or combinations thereof.

3. The process of claim 1 wherein the fuel cell comprises a solid oxide fuel cell or a carbonate fuel cell or both.

4. The process of claim 1 wherein the anode feed gas stream comprises natural gas.

5. The process of claim 1 wherein the CO₂ capture unit comprises a cryogenic CO₂ fractionation system, or a CO₂ PSA system, or a liquid solvent-based system, or combinations thereof.

6. The process of claim 1 wherein the process gas stream comprises a tail gas stream from a pressure swing adsorption (PSA) system, or an off gas stream from a kiln in a cement production process, or an off gas stream from a steel production process, or a synthesis gas stream from a biomass or waste gasification process, or combinations thereof.

7. The process of claim 1 wherein the process gas stream comprises a tail gas stream from a PSA system, and wherein a feed to the PSA system comprises a synthesis gas stream from a hydrogen production process, a synthesis gas stream from a biomass or waste gasification process, an off gas stream from a kiln in a cement production process, an off gas stream from a steel production process, or combinations thereof.

8. The process of claim 1 further comprising:
recovering hydrogen from the anode off gas stream in the CO₂ capture unit.

9. The process of claim 1 further comprising:
producing a residue gas stream comprising CO and methane in the CO₂ capture unit; and
recycling the residue gas stream to the fuel cell, or recycling the residue gas stream to the process, or both.

10. The process of claim 1 further comprising:
producing a decarbonized fuel gas stream comprising hydrogen and nitrogen in the CO₂ capture unit; and
combusting the decarbonized fuel gas stream a fired heater in the process or another process or both.

11. The process of claim 1 further comprising:
cooling the anode off gas stream; and
condensing water in the cooled anode off gas stream forming a condensed water stream and a cooled anode off gas stream; and
separating the condensed water stream from the cooled anode off gas stream;
wherein mixing the anode off gas stream with the process gas stream comprises mixing the cooled anode off gas stream with the process gas stream.

12. The process of claim 1 wherein the process gas stream has a pressure in a range of 100 to 180 kPa; or
wherein the anode off gas stream has a pressure in a range of 100 to 180 kPa;
or both.

13. The process of claim 1 wherein the anode off gas stream (on a dry basis) comprises 15 to 45 mol % hydrogen, or 45 to 65 mol % CO₂, or 5 to 15 mol % CO, or combinations thereof.

14. The process of claim 1 wherein the CO₂ capture unit produces:
a CO₂ product stream comprising CO₂ having a purity greater than or equal to 95 mol %; or
a hydrogen stream comprising hydrogen having a purity greater than or equal to 99 mol %; or
a residue gas stream comprising at least one of CO, methane, hydrogen, nitrogen, and argon; or
a fuel gas stream comprising a slip stream of the residue gas stream; or
a decarbonized fuel gas stream comprising hydrogen, and nitrogen or argon or both;
or combinations thereof.

15. A process for integrating a fuel cell with a process including a CO₂ capture unit comprising:
introducing an anode feed gas stream to an anode of a fuel cell and a cathode feed stream to a cathode of the fuel cell, wherein the anode feed gas stream comprises one or more of hydrogen, carbon monoxide, water vapor, and a hydrocarbon and the cathode feed stream comprises oxygen, or oxygen and CO₂, the fuel cell generating electricity and producing an anode off gas stream comprising CO₂ and at least one of hydrogen, CO, methane, water, and nitrogen, wherein the fuel cell comprises a solid oxide fuel cell or a carbonate fuel cell or both;
cooling the anode off gas stream;
condensing water in the cooled anode off gas stream forming a condensed water stream and a cooled anode off gas stream;
separating the condensed water stream from the cooled anode off gas stream;
mixing the cooled anode off gas stream with a process gas stream from the process to form a gas mixture, the process gas stream comprising CO₂ and at least one of nitrogen, oxygen, hydrogen, CO, methane, argon, and water;
compressing the gas mixture in a compressor to form a compressed gas mixture;
passing the compressed gas mixture to the CO₂ capture unit; and
recovering CO₂ in the CO₂ capture unit.

16. The process of claim 15 wherein the CO₂ capture unit comprises a cryogenic CO₂ fractionation system, or a CO₂ PSA system, or a liquid solvent-based system, or combinations thereof.

17. The process of claim 15 wherein the process gas stream comprises a tail gas stream from a pressure swing adsorption (PSA) system, or an off gas stream from a kiln in a cement production process, or an off gas stream from a steel production process, or a synthesis gas stream from a biomass or waste gasification process, or combinations thereof.

18. The process of claim 15 further comprising:
recovering hydrogen from the anode off gas stream in the CO₂ capture unit.

19. The process of claim 15 further comprising:
producing a residue gas stream comprising CO and methane in the CO₂ capture unit; and
recycling the residue gas stream to the fuel cell, or recycling the residue gas stream to the process, or both.

20. The process of claim 15 further comprising:
producing a decarbonized fuel gas stream comprising hydrogen and nitrogen in the CO₂ capture unit; and
combusting the decarbonized fuel gas stream a fired heater in the process or another process or both.
